(19) United States
(12) Patent Application Publication
(10) Pub. No.: US 2006/0013024 A1
(43) Pub. Date: Jan. 19, 2006

(54) Rectifier circuit having a power factor correction

(76) Inventors: Erno Temesi, Nagkovacsi (HU); Michael Frisch, Munich (DE); Jinghui Yu, Qingdao (CN)

Correspondence Address: BARLEY SNYDER, LLC, 1000 WESTLAKES DRIVE, SUITE 275, BERWYN, PA, 19312, US

(21) Appl. No.: 11/122,710

(22) Filed: May 5, 2005

(30) Foreign Application Priority Data
May 5, 2004 (EP) 04010619.7

(51) Int. Cl. H02M 1/12

(52) U.S. Cl. 363/44

(57) ABSTRACT

A rectifier circuit having a power factor correction and providing a DC output is disclosed. AC power having an AC oscillation is supplied at two or more AC inputs. The rectifier circuit includes at least two power factor correction stages which are directly coupled to one or more of the AC inputs, wherein each of the power factor correction stages controls a flow of current through the one or more coupled AC inputs so that the power factor is optimized. The power factor correction stages are designed to operate during different half waves of the AC oscillation with respect to one or more of the AC inputs.

### FIELD OF THE INVENTION

The present invention relates to a rectifier circuit, particularly to a rectifier circuit having power factor correction.

### BACKGROUND

For DC applications using AC power, a rectifier circuit is normally used in order to transform the AC power into a DC power provided to a DC load. The rectifier circuit normally includes a capacitance to smooth the DC output voltage. Due to the rectifier circuit, an AC current from the AC supply flows only if the instantaneous value of the AC voltage exceeds the capacitor voltage which results in short current pulses having a high current value. This can lead to interference on the AC power lines which affect other power consuming devices.

To avoid these high current pulses, a power factor correction unit is normally included in the rectifier circuit to ensure that voltage and current on the AC power lines are substantially in phase and that no current pulses are developed.

Conventionally, a rectifier circuit comprises a diode bridge including four diodes to rectify an AC power source so that a filtering capacitor is loaded. The voltage of the filtering capacitor can be supplied as the DC voltage to the DC outputs. As the filtering capacitor is only loaded if the voltage applied from the diode bridge is higher than the capacitor voltage, current peaks are developed. In order to avoid this, a power factor correction stage is introduced between the diode bridge and the filtering capacitor. The power factor correction stage normally includes a switch and a boost diode which are connected to the diode bridge via an inductor. The switch is controlled by a control circuit utilizing a frequency which is much higher than the frequency of the AC power.

By switching the switch, a boost voltage is developed via the inductor which is rectified by the boost diode and used for loading the filtering capacitor. The control circuit controls the switch in a manner that an AC current is drawn from the AC power line which is in phase with the AC voltage and sinusoidal (provided that the AC power is also supplied in a sinusoidal waveform) and has an amplitude to allow the DC outputs to supply a specific DC power. The efficiency of the power factor correction stage depends substantially on the number of electronic devices used in the rectifier circuit. Particularly, the number of diodes used in a current path affects the efficiency of the power factor correction.

### SUMMARY

It is therefore an object, among others, of the present invention to increase the power factor correction efficiency of a power factor correction stage of a rectifier circuit.

This and other objects are achieved by a rectifier circuit having a power factor correction and providing a DC output. AC power having an AC oscillation is supplied at two or more AC inputs. The rectifier circuit includes at least two power factor correction stages which are directly coupled to one or more of the AC inputs, wherein each of the power factor correction stages controls a flow of current through the one or more coupled AC inputs so that the power factor is optimized. The power factor correction stages are designed to operate during different half waves of the AC oscillation with respect to one or more of the AC inputs.

### BRIEF DESCRIPTION OF THE DRAWINGS

Embodiments of the present invention will discussed in detail with respect to the accompanying drawings, in which:

FIG. 1 shows a rectifier circuit according to a first embodiment of the present invention;

FIG. 2 shows a rectifier circuit according to a second embodiment of the present invention;

FIG. 3 shows the rectifier circuit of FIG. 1 including a current measuring device;

FIG. 4 shows a rectifier circuit according to a third embodiment of the present invention;

FIG. 5 shows a rectifier circuit according to a fourth embodiment of the present invention;

FIG. 6 shows a rectifier circuit according to a fifth embodiment of the present invention including a charge circuit; and

FIG. 7 shows a rectifier circuit according to the fifth embodiment of the present invention wherein a circuit of the charge circuit is given as an example.

### DETAILED DESCRIPTION OF THE EMBODIMENTS

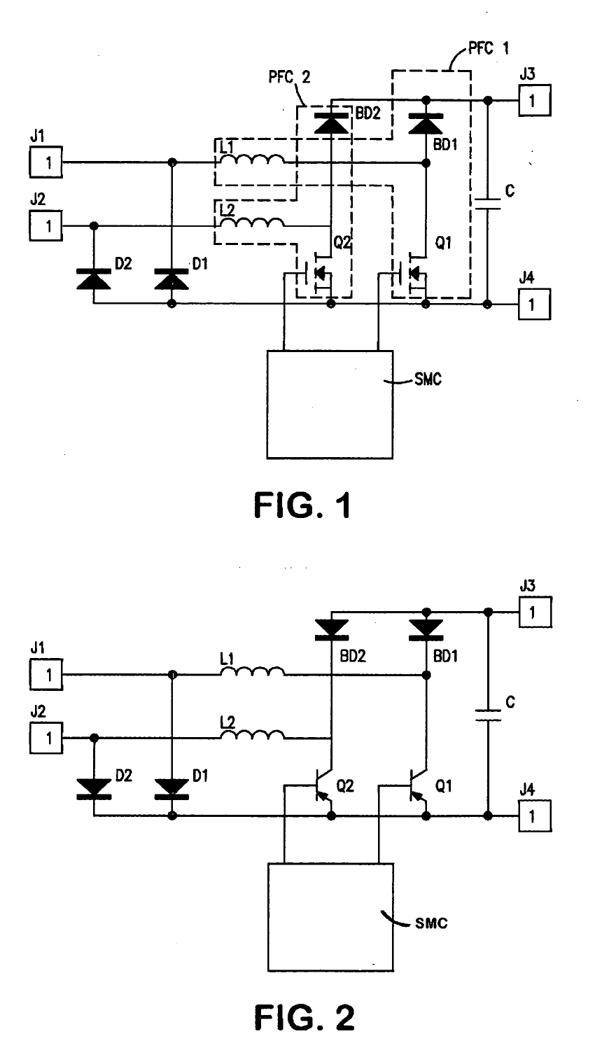

In FIG. 1 a rectifier circuit according to a first embodiment of the present invention is depicted. The rectifier circuit has a first AC input terminal J1 and a second AC input terminal J2. At each of the AC input terminals J1, J2, an AC voltage having a predetermined oscillation is provided, for example supplied by public power lines and the like. Furthermore, the rectifier circuit comprises two DC output terminals, a first DC output terminal J3 which has a positive potential and a second DC output terminal J4 which has a negative potential. The first AC input terminal J1 is directly connected to a first power factor correction stage PFC1 comprising a first inductor L1, a first boost diode BD1 and a first switch Q1. A second power factor correction stage PFC2 is directly connected to the second AC input terminal J2 and comprises a second inductor L2, a second boost diode BD2 and a second switch Q2. The first and second power factor correction stages are substantially equal in design, for example, the electrical characteristics of the boost diodes, the inductors and the switches are substantially equal.

Between the first DC output terminal J3 and the second DC output terminal J4 a filtering capacitor C is provided. The filtering capacitor C has the function to smooth the voltage between the DC outputs so that a variation of the output voltage due to the AC oscillation of the AC input voltage and/or an oscillation due to the power factor correction is decreased or eliminated.

As a first current control device associated to the first power factor correction stage PFC1, a first diode D1 is provided which is connected with its cathode to the first AC input terminal J1 and which is connected with its anode to the second DC output terminal J4. Similarly, a second diode D2 is provided which is associated to the second power factor correction stage PFC2 and which is connected with its cathode to the second AC input terminal J2 and with its anode to the second DC output J4. The first and second diode D1, D2 have the function to avoid a current backflow through the first or second switch Q1, Q2 to the respective AC input terminals J1, J2 by leading the current directly to the respective AC input terminal J1, J2 via the respective diode D1, D2.

Each of the power factor correction stages works by rapidly switching an inductor L1, L2 on and off between the respective AC input terminal J1, J2 and the second DC output terminal J4. By switching the respective inductor L1, L2, a voltage peak is induced which results in a flow of current through the respective boost diode BD1, BD2 if the potential at the first DC output terminal is lower than the voltage induced by the respective inductor. The switch of the power factor correction stage can be implemented as a MOSFET transistor, a bipolar transistor, an SCR device or such like.

The switches Q1, Q2 are controlled by a switch mode controller SMC which is connected to the control terminal of the switch, for example the gate terminal of MOSFETs. The switch mode controller SMC receives as inputs the AC input voltage, a measured current flow through the AC input terminals and the required DC output voltage. The switch mode controller SMC controls the current flow through the AC input terminals with reference to the AC input voltage. The switch mode controller SMC controls the AC currents so that the AC current is in phase with the AC voltage and comprises the same waveform.

The rectifier circuit according to FIG. 1 operates with the two power factor correction stages so that the first power factor correction stage PFC1 controls the current during a first half wave and the second power factor correction stage PFC2 operates during a second half wave of the AC input voltage. With positive and negative half waves of the AC input voltage as a reference, a mean value of the potentials of the provided AC input terminals J1, J2 is determined. With reference to the mean voltage value of the AC input voltages, a positive and a negative half wave can be determined. If a positive half wave is supplied by the first AC input terminal J1, the first inductor L1 of the first power factor correction stage PFC1 is loaded while the first switch Q1 is switched on. The first inductor L1 generates a high voltage peak having a positive voltage when the first switch Q1 is switched off. The positive voltage exceeds the voltage at the DC output terminal so that the boost diode BD1 is forward-biased and so that current can flow through the boost diode BD1 into the filtering capacitor C.

If a negative half wave is supplied by the first AC input terminal J1, the first rectifier diode D1 is forward biased so the first inductor L1 is not loaded. The negative voltage results in a reverse biasing of the first boost diode BD1 so that no current will flow to or from the first DC output terminal J3 through the first boost diode BD1. The function of the second power factor correction stage connected to the second AC input terminal J2 operates in the same manner.

When applying voltage to the AC input terminals, the terminal with the most negative voltage potential will forward-bias the rectifier diode D1, D2 connected to it while the AC input terminal with the positive voltage potential will reverse-bias the rectifier diode D1, D2 connected to it and allow it to control the current of the AC input terminal by the power factor correction stage connected to it. During a full phase of the AC input terminal, the sequential operation of the power factor correction stages results in a controlled input current for the whole phase of the AC input voltage.

The rectifier circuit of FIG. 1 has the advantage that the efficiency of the rectification can be increased as during one half wave only two P-N-transitions are included in the current path so that the efficiency can be improved. Conventionally, three or more diodes are provided in a current path of a conventional rectifier circuit having a power factor correction. The provision of two or more power factor correction stages allows omission of a full rectifying diode bridge resulting in increased efficiency of the power factor correction as only two instead of three diodes in the current path for each half wave are necessary.

In FIG. 2 a rectifier circuit according to another embodiment of the invention is depicted. The main differences between the embodiment of FIG. 2 and the embodiment of FIG. 1 is that in the embodiment of FIG. 2 the rectifier diodes D1, D2 and the boost diodes BD1, BD2 are connected the in reverse polarity, resulting in that the polarity between the output terminals J3, J4 is reversed. The function of the power factor correction stages PFC1, PFC2 is substantially similar to that discussed in FIG. 1.

The boost diodes BD1, BD2 are forward-biased if the voltage peaks supplied by the inductors L1, L2 are more negative than the voltage at the first DC output terminal J3. In the other cases, the boost diodes BD1, BD2 are reverse-biased. When applying voltage to the AC input terminals J1, J2, the AC input terminal with the most positive voltage potential will forward-bias the rectifier diode D1, D2 connected to it while the AC input terminal with negative voltage potential will reverse-bias the rectifier diode D1, D2 connected to it and allows it to control the current of the AC input terminal by the power factor correction stage connected to it. During a full phase of the AC input, the sequential operation of the power factor correction stages will result in a controlled input current for the whole phase of the AC input voltage.

Another difference between the embodiment of FIG. 1 and the embodiment of FIG. 2 lies in that the switches Q1, Q2 are realized as bipolar transistors in the embodiment of FIG. 2. As the MOSFET transistors of FIG. 1 and the bipolar transistors of FIG. 2 are used as switches, only the switching characteristics are important. The bipolar transistors of FIG. 2 can also be used with the embodiment of FIG. 1 as well as the MOSFET transistors of FIG. 1 can be used in the embodiment of FIG. 2.

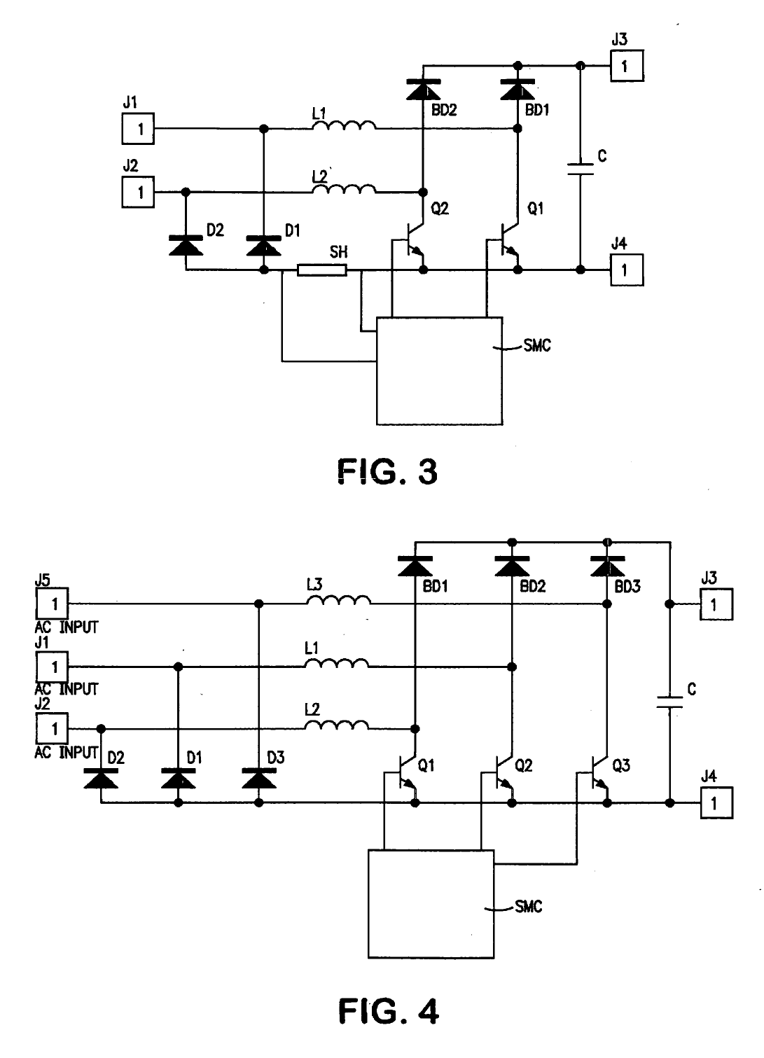

FIG. 3 shows substantially the embodiment of FIG. 1 wherein the switch mode controller is connected to a shunt resistor SH placed between the second DC output terminal J4 and the cathode terminals of the rectifier diodes D1, D2. The shunt resistor SH serves for measuring the AC input current and is used for controlling the current flow by the switch mode controller SMC. As indicated above, the AC current flow is to be controlled by the switch mode controller SMC and therefore represents a feedback input of the switch mode controller SMC. Not shown is that the switch mode controller SMC also receives as its input the AC input voltage as well as the DC output voltage.

FIG. 4 shows another embodiment of the present invention wherein the rectifier circuit has three AC input terminals J1, J2, J5 which are coupled to three separated power factor correction stages PFC1-PFC3. The power factor correction stages PFC1-PFC3 are of the type shown in FIG. 1 and FIG. 3, wherein the respective switches are provided as bipolar npn-transistors Q1, Q2, Q3. Each of the transistors is controlled by the common switch mode controller SMC.

The power factor correction stages PFC1-PFC3 comprise an inductor L1, L2, L3, a boost diode BD1, BD2, BD3 and the switch Q1, Q2, Q3, respectively. The switches Q1, Q2, Q3 are controlled separately, so that a three-phase power factor correction operation can be achieved. Similarly to the embodiments of FIG. 1 to FIG. 3, for each of the AC input terminals J1, J2, J5, a rectifier diode is provided wherein the respective rectifier diode D1, D2, D3 has its cathode connected to the second DC output terminal J4 and its anode to the AC input terminal J1, J2, J5, respectively.

When applying a voltage to the AC input terminals J3, J2, J5, the terminal with the most negative voltage potential will forward-bias the rectifier diode D1, D2, D3 connected to it while the other AC input terminals with a more positive voltage potential will reverse-bias the rectifier diodes connected to them and allow them to control the current of the AC input terminal by the power factor correction stage connected to them. Due to a full phase of the AC input, the sequential operation of the power factor correction stages PFC1-PFC3 will result in a controlled input current for the whole phase of the AC input voltage.

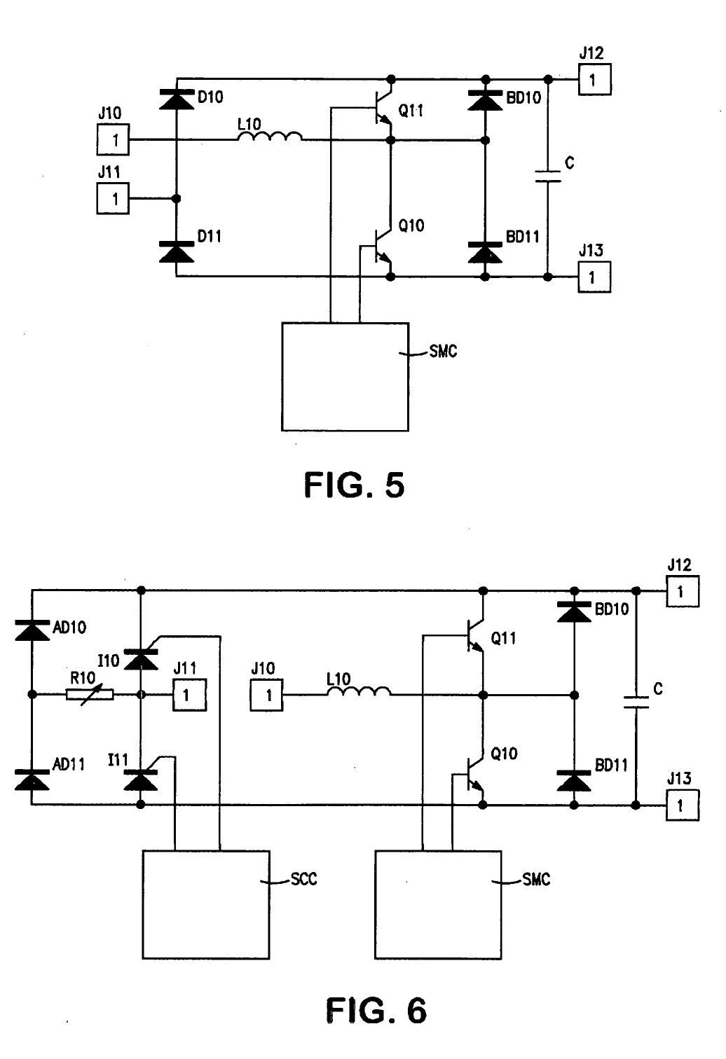

In FIG. 5, another embodiment of the present invention is depicted. The embodiment of FIG. 5 comprises two power factor correction stages PFC10, PFC11 coupled via one common inductor L10 to the first AC input terminal J10. A first power factor correction stage PFC10 includes a first switch Q10 and a first boost diode BD1 and the second power factor correction stage PFC11 comprises a second switch Q11 and a second boost diode BD11. Rectifying diodes D10, D11 are connected to a second AC input terminal J11 forming a rectifier half bridge.

Substantially, the embodiment of FIG. 5 shows a combination between the embodiments of FIG. 1 and FIG. 2 wherein a connection of the second AC input terminal J11 to a power factor correction stage can be omitted as all half waves of the AC input voltage are covered by the first and second power factor correction stages PFC10, PFC11. The second AC input terminal J11 is connected to the middle of the rectifier half bridge. The cathode of the first rectifier diode D10 is connected to the first DC output terminal J12 while the anode of the respective rectifier diode D10 is connected to the second AC input terminal J11. The second rectifier diode D11 is connected to the second AC input J11 with its cathode and connected to the second DC output terminal J13 with its anode.

When applying a voltage to the AC input terminals, the second AC input terminal J11 has more negative voltage potential than the first AC input terminal J10 and will forward-bias the second rectifier diode D11 of the rectifier half bridge connected to it. The first switch Q10 of the first power factor correction stage PFC10 controls the power factor from the AC source to the DC output terminals J12, J13 during this positive half wave of the AC input voltage. When the second AC input terminal J11 receives a more positive voltage potential than the first AC input terminal J10, the first rectifier diode D10 is forward-biased and the second power factor correction stage PFC11 boosts a negative voltage to the second DC output terminal J13. Similar to the functions of the embodiments of FIG. 1 to 3, the full phase of the AC input voltage is current controlled by controlling the current by the first power factor correction stage PFC10 during a first half wave and controlling a current with the second power factor correction stage PFC11 during a second half wave of the AC input voltage.

The switch mode controller SMC controls the first and second switches Q10, Q11 so that both switches are not switched on at the same time.

In FIG. 6, a rectifier circuit according to another embodiment of the present invention is depicted. The rectifier circuit is similar to the embodiment of FIG. 5, however, in place of the rectifier half bridge, SCR devices I10, I11 are used. Same reference signs indicate same elements of the rectifier circuit. Control terminals of the SCR devices I10, I11 are connected to a surge current controller SCC which detects if a filtering capacitor C is charged to a predetermined level and after detecting this the surge current controller SCC switches on the SCR devices I10, I11, thereby representing the function of a conventional rectifying diode.

Furthermore, a charge circuit is provided comprising at least one current limiting element R10 which is connected to the second AC input terminal J11 in series with a first auxiliary diode AD10 connected by its cathode to the first DC output terminal J12 and by its anode to the current limiting element R1 and a second auxiliary diode AD11 connected to the second DC output terminal J13 with its anode and connected to the current limiting element R1 by its cathode.

When switching on the AC power on the AC input terminals J10, J11, the surge current controller SCC do not switch on the SCR devices I10, I11 immediately. The load current to the filtering capacitor C is controlled by the current limiting element R1 through the auxiliary diodes AD10, AD11. The surge current controller SCC may also have the function that in case of over-current on the DC output terminals, the firing of the SCR devices I10, I11 is stopped and thereby the current is limited by the current limiting elements and the auxiliary diodes AD10, AD11.

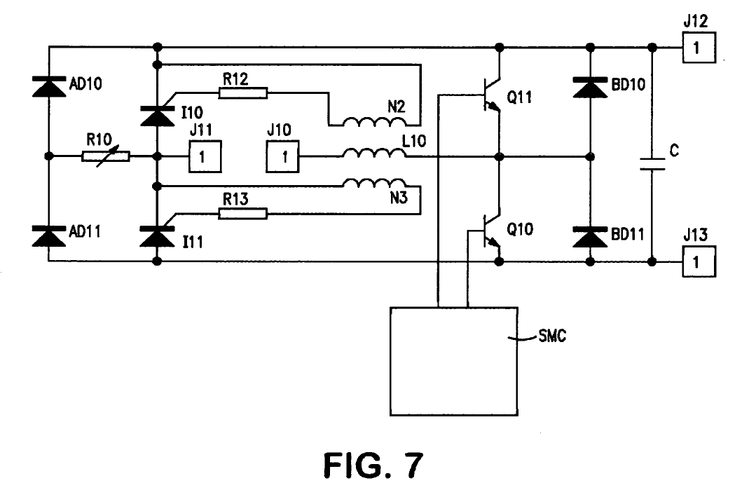

In FIG. 7 one possibility to realize the surge current controller SCC is indicated. The rectifier circuit according to FIG. 7 is substantially the same as in the embodiment of FIG. 6 wherein the surge current controller is realized by a second and third winding N2, N3 of the common inductor L10 which are coupled to the control terminal of the SCR devices I10, I11 via a second and a third resistor R12, R13, respectively. The firing of the SCR devices I10, I11 is automatically controlled by appropriate voltage from the feedback windings N2, N3 of the common inductor L10. In an advantageous form, N2 is polarized in such a way that when the first SCR device receives a firing pulse when the first AC input terminal J10 is more positive than the second AC input terminal J11 and the third windings N3 are polarized in that way that the second SCR device I11 receives a firing pulse when the second AC input terminal J11 is more positive than the first AC input terminal J10. The voltage transformer formed by windings N2, N3 and by the common inductor L10 can also be polarized in another way as the SCR devices can trigger at both current directions through the common inductor L10. The components of the surge current controller SCC, i.e. the second resistor R12, the third resistor R13, the second winding N2, and the third winding N3 are selected to fire the SCR devices I10, I11 at a time when a desired DC output voltage level is exceeded, thereby totally eliminating in-rush current.

What is claimed is:

1. A Rectifier circuit having a power factor correction and providing a DC output, comprising:
two or more AC inputs to provide AC power and
at least two power factor correction stages which are directly coupled with one or more of the AC inputs, wherein each of the power factor correction stages controls a flow of current through the one or more coupled AC inputs so that the power factor is optimized;
wherein the power factor correction stages operate during different half waves of an AC oscillation on one or more of the AC inputs.

2. The rectifier circuit according to claim 1, wherein each of the power factor correction stages includes an inductor which is respectively coupled to one of the AC inputs.

3. The rectifier circuit according to claim 2, wherein a current control device is provided for each of the power factor correction stages preventing a back flow of current through the respective power factor correction stage.

4. The rectifier circuit according to claim 3, wherein each of the power factor correction stages includes a boost diode and a semiconductor switching device, wherein each of the current control devices prevents the semiconductor switching device from being reverse biased.

5. The rectifier circuit according to claim 4, wherein at least one of the current control devices includes a diode which is connected so that the diode is forward biased between the associated power factor correction stage and the AC input to prevent a reverse bias voltage on the semiconductor switching device during one of the half waves.

6. The rectifier circuit according to claim 1, wherein the at least two power factor correction stages are coupled to one of the AC inputs via a common inductor which is directly coupled to the one AC input, wherein the power factor correction stages are designed to operate on different half waves of the AC power wherein one of the power factor correction stages controls a flow of current at the one AC input during the one half wave and another of the power factor correction stages controls a flow of current at the one AC input during the other half wave.

7. The rectifier circuit according to claim 6, wherein a current control device is provided for each of the power factor correction stages preventing a back flow of current through the respective power factor correction stage.

8. The rectifier circuit according to claim 7, wherein each of the current control devices prevents the respective semiconductor switching device from being reverse biased.

9. The rectifier circuit according to claim 8, wherein each of the power factor correction stages includes a boost diode and a semiconductor switching device, wherein one of the power factor correction stages boosts a voltage at the one half wave of the AC input to a first DC output terminal and wherein the other of the power factor correction stages boosts a voltage at the other half wave of the AC input to a second DC output terminal.

10. The rectifier circuit according to claim 9, wherein one of the current control devices associated to the one power factor correction stage includes a diode which is arranged so that the diode is forward biased between the one power factor correction stage and the one AC input to prevent a reverse bias voltage on the semiconductor switching device of the one power factor correction stage during the other half wave.

11. The rectifier circuit according to claim 10 wherein the other of the current control devices associated to the other power factor correction stage includes another diode which is arranged so that the other diode is forward biased between the other power factor correction stage and the one AC input to prevent a reverse bias voltage on the semiconductor switching device of the other power factor correction stage during the one half wave.

12. The rectifier circuit according to claim 11, wherein a charge circuit is provided to charge a capacitor between a first and a second DC output during an initial phase, wherein the charge circuit comprises a charging current control device including a current limiting device to operate the rectifier circuit in reduced current mode during the initial phase and wherein the current control device is in operation if the capacitor is loaded to a predetermined level.

13. The rectifier circuit according to claim 12, wherein the charge circuit is controlled by a charging controller wherein the charging controller switches the current control device depending on the voltage through the common inductor.
